(19) United States
(12) Patent Application Publication
(10) Pub. No.: US 2026/0050546 A1
(43) Pub. Date: Feb. 19, 2026

(54) INFORMATION PROCESSING APPARATUS AND METHOD

(71) Applicant: Sony Interactive Entertainment Inc., Tokyo (JP)

(72) Inventor: Daniel Hartnett, London (GB)

(21) Appl. No.: 19/299,120

(22) Filed: Aug. 13, 2025

(30) Foreign Application Priority Data
Aug. 14, 2024 (GB) 2411958.8

(51) Int. Cl. G06F 12/02

(52) U.S. Cl. CPC G06F 12/023; G06F 2212/1016

(57) ABSTRACT

An information processing apparatus comprises input circuitry to receive memory allocation information for a plurality of memory allocations comprising time information and memory address information for a respective memory allocation, mapping circuitry to map the time information and the memory address information for the respective memory allocation to a one-dimensional key of a space-filling curve, storage circuitry to store tile information comprising a plurality of tiles, a respective tile corresponding to a portion of the two-dimensional space and comprising entries associated with keys corresponding to that portion of the two-dimensional space, selection circuitry to select at least some of the tile information in dependence on a user input, and image processing circuitry to generate one or more images for display in dependence on the at least some of the tile information.

### CROSS-REFERENCE TO RELATED APPLICATIONS

This application claims the benefit of priority to G.B. Application No. 2411958.8, filed on Aug. 14, 2024, the contents of which are hereby incorporated by reference.

### BACKGROUND OF THE INVENTION

### Field of the Invention

This disclosure relates to an information processing apparatus and method.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Various runtime analysis tools exist for capturing information during execution of programs for debugging and validation purposes. Among these, memory profilers and other similar tools are typically used for capturing memory usage information when running programs.

Obtaining memory usage information can provide insight for developers into the behaviour of programs and processes, which can be useful for assisting in optimisation of program code. In particular, capturing and evaluation of information regarding memory allocations can be beneficial for gaining insight into program behaviour and identifying problematic and/or inefficient behaviours such as areas of fragmentation and patterns that can lead to memory leaks. However, memory allocation information captured by memory profiles and other similar tools is typically comprised of large numbers of allocation events across time ranges and memory space which can pose challenges for efficient processing of such information. Moreover, memory allocation information captured for some memory intensive applications, such as video games, can potentially comprise large numbers of memory allocation events of the order of thousands or even millions.

It is in the context of the above discussion that the present disclosure arises.

### SUMMARY OF THE INVENTION

The invention is defined by the claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an information processing apparatus;

FIG. 2 schematically illustrates an example of mapping time information and memory address information to one-dimensional keys;

FIG. 3 schematically illustrates an example of a user input indicative of 2D coordinates for defining a query range; and

FIG. 4 schematically illustrates an example of a display image for visualising a portion of the memory allocation information; and

FIG. 5 is a schematic flowchart illustrating a method.

### DESCRIPTION OF THE EMBODIMENTS

Referring now to the drawings, wherein like reference numerals designate identical or corresponding parts throughout the several views, non-limiting embodiments of the present disclosure are described.

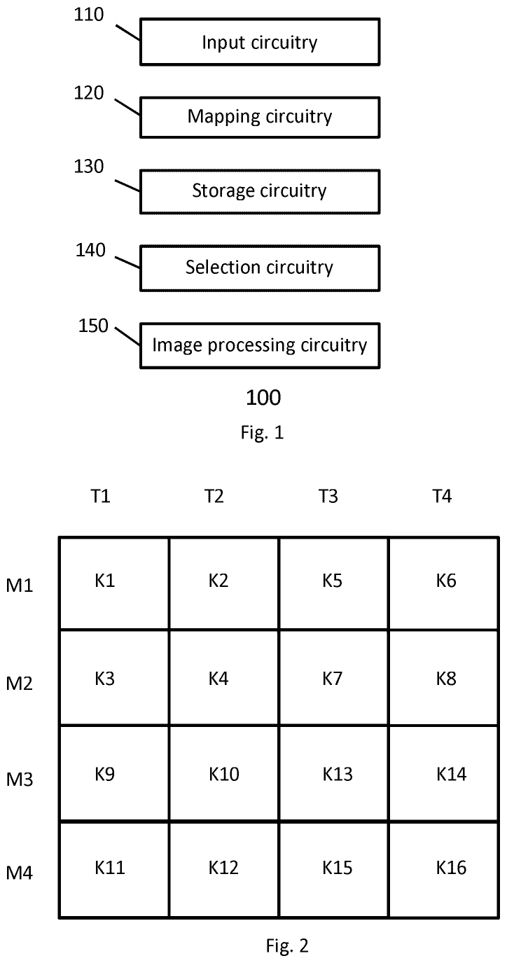

FIG. 1 schematically illustrates an information processing apparatus 100 in accordance with embodiments of the disclosure. The information processing apparatus 100 may be provided as part of a processing device such as a server or a personal computing device. The information processing apparatus 100 comprises one or more CPUs and/or one or more GPUs for performing the processing operations to be discussed below and may comprise any suitable storage. The information processing apparatus 100 may transmit and/or receive data via one or more data ports, such as a universal serial bus (USB) port, Ethernet® port, Wi-Fi® port, Bluetooth® port or similar, as appropriate.

As shown in FIG. 1, the data processing apparatus 100 comprises input circuitry 110, mapping circuitry 120, storage circuitry 130, selection circuitry 140 and image processing circuitry 150. The input circuitry 110 is configured to receive memory allocation information for a plurality of memory allocations associated with execution of a program. The memory allocation information may have been captured using any suitable software and/or specifically configured hardware. For example, the Eclipse Memory Analyzer Tool (MAT) is an example of a suitable tool for this purpose. Techniques for capturing memory allocation information for execution of programs are generally known and are not discussed in detail. In some examples, the memory allocation information may have been captured by the information processing apparatus 100 and stored by storage provided as part of the information processing apparatus 100, or stored externally on another device. In other examples, the memory allocation information may have been captured by another processing device and can be received via one or more of a wired and/or wireless communication. More generally, the memory allocation information may be received by the input circuitry 110 from one or more of a storage provided as part of the information processing apparatus 100 and another processing device.

The memory allocation information comprises time information and memory address information for a respective memory allocation, in which the time information is indicative of a start time and an end time for the respective memory allocation. The memory allocation information thus provides an indication of a start time, an end time and a memory address for individual memory allocations. The memory allocation information may relate to a potentially large number of allocations, which may potentially be of the order of thousands, hundreds of thousands or even millions. Start time, end time and memory address can be included in the memory allocation information for each of the respective memory allocations.

For example, in the C programming language, dynamic memory allocation during running of a program may use the functions malloc( ), calloc( ), realloc( ) and free( ) and calls to these functions and memory addresses may be captured by a suitable profiling tool for creating the memory allocation information for a given program. In particular, timings associated with the start of a memory address allocation and a deallocation of that memory address can be captured.

In the case of capturing the memory allocation information for running of a program on a 64-bit computing device, then 64-bit time and memory information may be obtained. Hence, in some embodiments of the disclosure, the time information for a memory allocation may comprise a 64-bit code indicative of a start time for the memory allocation and a 64-bit code indicative of an end time for the memory allocation. The memory address information may comprise a 64-bit code indicative of a memory address for a respective allocation. Other possibilities are also considered and the techniques of the present disclosure are not limited to 64-bit information. In some cases, one or more processing operations may be performed with respect to bits of the time information and/or memory address information so as to select a subset (some) of the bits for mapping to keys. This is discussed in more detail later.

The mapping circuitry 120 is configured to map the time information and the memory address information for a respective memory allocation to a one-dimensional key of a space-filling curve, in which unique one-dimensional keys of the space-filling curve correspond to respective points in a two-dimensional space having a time axis and a memory address axis. Put differently, the mapping circuitry maps an input comprising time information and memory address information (i.e. a two-dimensional input) to a one-dimensional key. Different one-dimensional keys correspond to different points of the space-filling curve. The space-filling curve fills the two-dimensional space having a time axis and a memory address axis. Any suitable space-filling curve which fills a two-dimensional plane may be used. Examples of suitable space-filling curves are a Hilbert space-filling curve, a Peano space-filling curve and a Morton space-filling curve (also referred to as a Z-order curve). In an example, the time axis represents the start time of the memory allocation.

More generally, the mapping circuitry is operable to map first time information and first memory address information for a first respective memory allocation to a first 1D key of the space-filling curve. Similarly, the mapping circuitry is operable to map second time information and second memory address information for a second respective memory allocation to a second 1D key of the space-filling curve, and so on for each of the memory allocations. Therefore, the memory allocations, which are each comprised of a two-dimensional time and memory address, can be considered as being indexed on the basis of one-dimensional keys.

The storage circuitry 130 stores tile information comprising a plurality of tiles in which a respective tile corresponds to a portion of the two-dimensional time-address space filled by the space-filling curve. The two-dimensional space can be segmented into two-dimensional tiles so that each tile corresponds to a two-dimensional portion of the two-dimensional space. A respective tile corresponds to a portion of the 2D space and comprises entries that are associated with the 1D keys of the space-filling curve corresponding to that 2D portion of the two-dimensional space.

As explained in more detail below, the stored tile information comprises entries (data storage entries) which are each associated with a 1D key of the space-filling curve and which are available to be used for storing information. The storage circuitry may comprise any suitable memory such a volatile and/or non-volatile memory for storing the tile information. By mapping the time information and the memory address information for a respective memory allocation to a 1D key, a respective entry of the tile information associated with the 1D key obtained for the respective memory allocation can be identified and used to store the time information and the memory address information for that respective memory allocation. The information (time and memory) can thus be stored and indexed by unique 1D keys so that information can be retrieved on the basis of 1D keys.

In some examples, at least some or all of the plurality of tiles may be set-up in advance of the mapping operations by the mapping circuitry. Hence, the storage circuitry 130 may store a plurality of tiles each comprising entries associated with the 1D keys of the space-filling curve corresponding to the portion of the two-dimensional time-address space associated with that tile and, in response to the mapping circuitry mapping the information for a respective memory allocation to a 1D key, matching of the 1D key obtained by the mapping circuitry to an entry of a tile may be performed to identify the appropriate entry and store (e.g. fill) the entry with the information for the respective memory allocation.

Alternatively or in addition, at least some or all of the plurality of tiles may be set-up as an on-going process according to the 1D keys being obtained by the mapping operations by the mapping circuitry. For example, in response to the mapping circuitry mapping the information for a respective memory allocation to a 1D key, a check may be performed as to whether the stored tile information comprises a tile having an entry for that 1D key, and if not then a tile may be created which comprises entries associated with 1D keys, for which a respective entry is associated with a 1D key that matches that obtained for the respective memory allocation by the mapping circuitry.

A respective tile comprises entries associated with 1D keys of the space-filling curve, and the storage circuitry 130 stores the time information and the memory address information for a respective memory allocation in an entry associated with the 1D key obtained by the mapping circuitry for the respective memory allocation. For example, a 1D key matching approach may be used to identify an entry associated with a 1D key that matches the 1D key obtained by the mapping circuitry for the respective memory allocation.

More generally, the information processing apparatus 100 processes the received memory allocation information so as to obtain the tile information comprising entries associated with 1D keys and for which at least some of the entries store information (time and memory address) for a respective memory allocation in the received memory allocation information. The properties of the tile information allow for faster and more efficient information searching and retrieval compared to, for example, storing the memory allocation information in a conventional database and using conventional database searching techniques. For example, storing the received memory allocation information in the form in which it is received (e.g. using a 2D array comprising a row for each captured allocation event and two columns for time and address, respectively) and performing array searches to search for and retrieve each allocation event in a requested 2D time-address range represents a slow and computationally inefficient technique. In the present disclosure, the tile information comprises respective tiles each comprising entries such that a respective tile can store information for some of the memory allocations, and information searching and retrieval can be performed at a tile level and using 1D keys to allow quick and efficient searching and retrieval. Hence, the stored tile information represents an efficient data storage which can advantageously allow for quick and efficient processing for generating one or more images for displaying one or more visualisations of the received memory allocation information.

In some examples, each of the plurality of tiles corresponds to a respective portion of the two-dimensional space and each tile of the of the plurality of tiles has a same size and is non-overlapping with another tile of the plurality of tiles. In some examples, the plurality of tiles may comprises one or more first tiles having a first size and one or more second tiles having a second size. More generally, in some cases the plurality of tiles may comprise tiles having two or more different tile sizes. The tiles may have a substantially square shape and/or a rectangular shape with respect to the two-dimensional space.

The information processing apparatus comprises selection circuitry 140 to select at least some of the tile information in dependence on a user input and image processing circuitry 150 configured to generate one or more images for display in dependence on at least some of the tile information. The selection circuitry is operable to select, from the tile information stored by the storage circuitry 130, at least some or all of the stored tile information in dependence on the user input and the information associated with the selection can be used by the image processing circuitry for generating one or more images for display. For example, a user input may specify that a single view of all of the memory allocation information is requested and the selection circuitry may select all of the stored tile information. Alternatively, a user input may specify that a portion (e.g. a time range and memory address range) of the memory allocation information is requested and the selection circuitry may select a portion of the stored tile information in dependence on the user input. Techniques regarding selection with respect to the stored tile information in dependence on a user input are discussed in more detail later.

The image processing circuitry thus generates one or more images for displaying one or more 2D visualisations of memory allocations included in the received memory allocation information. In some examples, the information processing apparatus comprises a screen for displaying one or more of the images generated by the image processing circuitry 150. Alternatively or in addition, the information processing apparatus may output one or more of the images for display by an external display device via one or more of a wired and/or wireless communication. An example of a device for displaying images output by the information processing apparatus is a television.

As a consequence of using the tile information, the one or more images can thus be generated with improved timing characteristics. In particular, data searching and retrieval can be faster and more efficient by virtue of allowing querying of tiles using 1D keys, and images can be generated for displaying requested portions of the memory allocation information with reduced time delay between a request from the user and output of the image for display to the user. In particular, the information processing apparatus can be particularly beneficial for allowing visualisation of large data sets comprising potentially large numbers of memory allocations for which conventional 2D array based database searching and retrieval techniques may potentially involve inordinately lengthy delays between a user requesting a portion of the data and being presented with an image for visualising that portion.

A single display image including a 2D visualisation for providing a view of all or almost all (e.g. a majority) of the memory allocations in the memory allocation information is generally not capable of displaying the finer details of respective allocations in the memory allocation information, which may be of importance for tasks such as debugging and code optimisation. This is particularly the case for datasets with larger numbers of allocation events spanning a range of memory addresses and times. Hence, when viewing a first image (e.g. an image generated in dependence on all or a majority of the stored tile information to provide a high-level view of the memory allocation information) generated by the image processing circuitry 150, a user may then request to view a portion of the memory allocation (e.g. by specifying a 2D range to be viewed in a next image). Conventional database searching techniques using two-dimensional array look-up would typically require a long search time for retrieving the appropriate data, thus inhibiting interactive viewing experiences.

In the present disclosure, the image processing circuitry 150 is operable to generate one or more images for display in dependence on at least some of the tile information and, in response to receiving a request from a user for a more detailed view of a portion of the memory allocation information (e.g. by selecting a portion of the above mentioned first image), the stored tile information can be quickly and efficiently searched to select (e.g. retrieve) the information for generating a subsequent image for providing the more detailed view. Hence, the information processing apparatus 100 can potentially allow images to be generated for displaying portions of the memory allocation information (e.g. specified ranges of memory addresses and time with respect to a display image) with improved timing characteristics. In particular, images can be generated for displaying user-requested portions of the memory allocation information with an amount of time from receiving a user request to outputting the image being such that 2D visualisations can be generated and displayed at potentially interactive frame rates.

As explained above, the unique one-dimensional keys of the space-filling curve correspond to respective points in the two-dimensional space having the time axis and the memory address axis, and any suitable space-filling curve may be used. In some embodiments of the disclosure, the space-filling curve is a Morton space-filling curve, and the mapping circuitry is configured to map the time information and the memory address information using a Morton function. The mapping circuitry can perform bit-interleaving with respect to the bits of the time information and the memory address information for a memory allocation to obtain the 1D key as a Morton code.

For example, 64-bit time information and 64-bit memory address information may be bit-interleaved to obtain a 128-bit key. In other examples, 32-bit time information and 32-bit memory address information may be bit-interleaved to obtain a 64-bit key. As explained in more detail later, in some examples the received memory allocation information may comprise 64-bit time information and 64-bit memory address information, and the mapping circuitry can be configured to select a subset of the bits of the time information and a subset of the bits of the memory address information to obtain a selected set of 32-bits of the time information and a selected set of 32-bits of the memory address information and perform bit-interleaving of the two sets of 32-bits to obtain a 64-bit key. Hence more generally, in some embodiments of the disclosure the space-filling curve may have unique one dimensional keys that are 128-bit keys or 64-bit keys. Performing bit selection with respect to the received information (time and/or memory address information) to obtain a subset of the bits can provide significant performance benefits (e.g. by reducing storage requirements and potentially allowing faster key-based searching).

FIG. 2 is a schematic diagram illustrating an example of a correspondence between keys of a space-filling curve and a two-dimensional space having a time axis and a memory address axis. FIG. 2 shows an example of a Morton space-filling curve (a Z-order curve) and the corresponding keys for a portion of the two-dimensional space. Time (e.g. memory allocation start time) is represented in the horizontal axis with the values T1-T4 and memory address is represented in the vertical axis with the values M1-M4. The keys K1-K16 are schematically shown as corresponding to subdivisions of the 2D space and the space-filling curve (not drawn in FIG. 2) has a continuous path that traverses the 2D space in order from K1 to K2, K2 to K3 and so on to K16. Hence in the example of FIG. 2 it can be seen that the space-filling curve has a Z-order (or Morton order). When using the Morton function, the mapping circuitry is operable to map T1 and M1 to the key K1 by performing bit-interleaving of the bits of T1 and M1. Similarly, bit-interleaving of the bits of T2 and M1 obtains the key K2. Therefore, FIG. 2 schematically illustrates an example of mapping time information and memory address information to one-dimensional keys of a Morton space-filling curve using bit-interleaving. Of course, the techniques of the present disclosure are not limited to the use of the Morton space-filling curve, and in some embodiments of the disclosure a Hilbert space-filling curve may instead be used.

The example of FIG. 2 schematically illustrates a portion of the two-dimensional space corresponding to a set of 1D keys. In some examples, the portion shown in FIG. 2 may correspond to a respective tile (that is, a whole, single, tile), or may correspond to a part of a tile (e.g. 1/N of a tile, where N is a value in the range 2 to 1000). Hence, FIG. 2 represents an example of a tile corresponding to 16 1D keys and comprising entries associated with each of the 1D keys. However, more generally, the tile information relates to a plurality of tiles, in which a tile corresponds to X respective keys and the tile comprises an entry associated with each of the X respective keys, where X=1 or more.

### Mapping Memory Allocation Information to Keys

The memory allocation information may be generated by any suitable profiling tool. An example of such a tool is the Eclipse Memory Analyzer Tool (MAT) which supports 64-bit time and memory address information. More generally, in some cases the memory allocation information may be captured for a program run by a 64-bit machine that uses 64-bit values for time and memory address. Whilst the information processing apparatus can be operable to map 64-bit time information and 64-bit memory address information to 128-bit keys, the use of such keys can be costly in terms of storage and processing. Therefore, in some embodiments of the disclosure, the information processing apparatus is operable to perform one or more operations with respect to one or both of the time information and the memory address information to obtain a subset of the bits of one or both of the time information and the memory address information.

In some embodiments of the disclosure, in response to the receiving circuitry receiving at least one of time information comprising an M-bit binary code and memory address information comprising an M-bit binary code, wherein M is a value in the range 33 to 64, the mapping circuitry is configured to map 32-bits of the time information and 32-bits of the memory address information to a 64-bit binary code as the one dimensional key. For example, M may be equal to 64 and may be the same for both the time information and the memory address information. Alternatively, some machines may use 48-bit addresses and the received memory address information may comprise 48-bit memory addresses.

The mapping circuitry can be configured to perform selection with respect to the bits of at least one of the time information and memory address information to obtain one or more of a selected set of 32-bits of the time information and a selected set of 32-bits of the memory address information and then map the two sets of 32-bits to a 64-bit key. As explained previously, this mapping may potentially use a Morton function, for example, for mapping the two sets of bits to the 64-bit key by performing bit-interleaving.

In some embodiments of the disclosure, in response to the time information comprising a 64-bit binary code, the mapping circuitry is configured to remove the 16 least significant bits (LSB) and the 16 most significant bits (MSB) of the time information. 64-bit time information can thus be processed so that 32-bits of the time information are used by the mapping circuitry for mapping to a 1D key. For example, in some cases 64-bit time information captured by a profiling tool may have microsecond resolution whilst also being capable of representing a period of the order of years. The inventor has appreciated that at least some of these bits can be considered superfluous since respective memory allocations are capable of being distinguished (and thus mapped to different 1D keys) using just some of the total number of bits and that certain bits can thus be disregarded to allow for use of a shortened 64-bit key. Hence, 32-bits of the time information can be selected for use in mapping to a 1D key so that 64-bit keys can be used rather than having to use more costly 128-bit keys.

In some embodiments of the disclosure, in response to the memory address information comprising a 64-bit binary code, the mapping circuitry is configured to remove the 16 least significant bits (LSB) and the 16 most significant bits (MSB) of the memory address information. Furthermore, some x64 hardware supports 48-bit memory addresses. In this case, the mapping circuitry can be operable to remove the 16 most significant bits to obtain the 32-bits to be used for the mapping. In this way, 32-bits of memory address information can be obtained for use in mapping to a 64-bit key. For example, in some cases 64-bit or 48-bit memory address information may be captured by a profiling tool. Since respective memory allocations are capable of being distinguished (and thus mapped to different 1D keys) using just some of the total number of bits of the memory address information, certain bits can thus be disregarded to allow for use of a shortened 64-bit key. Hence, 32-bits of the memory address information can be selected for use in mapping to a 1D key so that 64-bit keys can be used rather than having to use more costly 128-bit keys.

### Storage of Tile Information

The tile information can generally be stored using one or more data structures for assisting in quick and efficient querying of the tile information based on 1D keys derived in dependence on a user input. In some embodiments of the disclosure, the storage circuitry stores the tile information using one or more from the list consisting of: an associative array; a hash table; and one or more search trees, in which the one or more search trees comprises one or more of: a binary search tree; a radix tree; and an adaptive radix tree. Techniques for deriving 1D keys based on a user input are discussed in more detail later. Generally, 1D keys can be derived in dependence on a user input requesting a portion of the memory allocation information and the selection circuitry is operable to query one or more data structures based on the 1D keys to select portions of the stored tile information.

The tile information may be stored using an associative array indexed by 1D keys. Alternatively or in addition, the tile information may be stored using a hash table (also known as a hash map) in which derived 1D keys (derived in dependence on a user input) are mapped by a hash function to compute an index (also referred to as a hash code) associated with an entry of the hash table (e.g. bucket or slot) from which the information can be retrieved. Hence more generally, during a look-up operation a 1D key can be hashed to obtain a hash code for indicating a storage location of the desired information.

However, associative arrays and hash tables only support point queries. It is expected that a user may desire to view an image including a 2D representation of a portion of the memory allocation information, such as a plot showing memory address versus time, so as to simultaneously view a number of memory allocation events, which may be of the order of hundreds, thousands or even millions. More generally, it is expected that a user may desire to view an image that simultaneously displays a number of allocation events within a time range and memory address range and may desire to request and view such images at potentially interactive frame rates.

Hence, in the specific case of memory allocation information it is generally desirable for the tile information to be stored using one or more data structures which allow for range querying of the tile information. It is desirable for the tile information to be stored using one or more data structures that support range querying so that derived 1D keys can be used to perform a range query that quickly and efficiently returns information for a potentially large number of memory allocation events within a specified range. Conventional associative arrays and hash tables, whilst potentially suitable for returning individual pieces of data and small numbers of data items, generally do not scale well for large datasets and can potentially result in long wait times when used for returning information for a large number of allocation events, and thus may prevent realisation of displaying 2D visualisations of memory allocation information at substantially interactive frame rates.

Hence, in some embodiments of the disclosure, the storage circuitry can be configured to store the tile information using one or more search trees which permit range querying using derived 1D keys. Various types of search tree are considered such as a binary search tree, a radix tree and an adaptive radix tree. The information processing apparatus can be configured to construct one or more of a search tree, a radix tree and an adaptive radix tree for storing the tile information and which can be queried based on 1D keys derived from a user input. Hence, a user input specifying a 2D range (a time range and a memory address range) can be mapped to at least two 1D keys which define an upper and lower limit for a range query. Range queries with respect to search trees are generally known and are not discussed in detail.

A range query on a search tree (e.g. binary search tree) reports the nodes of the tree that fall within the range so that information (time information and memory address information for respective memory allocations) associated with those nodes can be reported. In particular, a range query on a search tree using a first key and a second key will generally result in two search paths that diverge at a given node within the search tree and on this basis, nodes in one or more sub-trees can be reported as being within the range. For example, in the case of a binary search tree, a given node has a left subtree comprising nodes for which all the keys are less than that of the given node and a right subtree comprising nodes for which all the keys are greater than the of the given node. Hence, this property of a binary search tree can be exploited so that a given node at which the two search paths diverge can be used to quickly and efficiently report the nodes within the range and thus the information associated with those nodes. Morton codes can be particularly suited to use with search trees such as a binary search tree, a radix tree and an adaptive radix tree. Generally, the adaptive radix tree can allow use of nodes with partial keys. Examples of techniques employing adaptive radix trees are discussed in detail in Leis et al., “The Adaptive Radix Tree: ARTful Indexing for Main-Memory Databases”, the entire contents of which are incorporated by reference.

Hence, in some embodiments of the disclosure the storage circuitry stores the tile information using one or more of a binary search tree, a radix tree and an adaptive radix tree. Within the stored tile information, a subset of the tiles corresponding to a range query can be quickly and efficiently returned responsive to a user input. Consequently, quick and efficient range querying of the tile information can allow respective tiles within the query range to be returned and one or more images can be generated by the image processing circuitry with an amount of time from receiving a user request to outputting the image being such that 2D visualisations can be generated and displayed at potentially interactive frame rates.

### Tile Information Querying

The information processing apparatus may receive one or more user inputs from an input device that communicates with the information processing apparatus via one or more of a wired and wireless (e.g. Bluetooth®) communication. For example, peripheral devices such as a mouse (or more generally a pointing device), keyboard and/or videogame controller may be used. Alternatively or in addition, one or more user inputs may be provided using one or more input elements (e.g. buttons, a touch pad and/or a touchscreen) which may be provided as part of the information processing apparatus 100 and/or as part of an external processing device.

In some examples, the information processing apparatus may transmit one or more of the generated images for display by an external device comprising a touchscreen and user inputs detected by a touch panel of the touchscreen may be communicated to the information processing apparatus for use by the information processing apparatus for selection of a portion of the tile information for generating another image to be displayed on the touchscreen.

In some embodiments of the disclosure, a system comprises the information processing apparatus 100; one or more user input devices configured to communicate input signals to the information processing apparatus 100 via a wired and/or wireless communication in response to user operation of one or more of the user input devices; and one or more display devices (e.g. television and/or HMD) configured to display one or more of the images generated by the image processing circuitry 140.

In some embodiments of the disclosure, the information processing apparatus 100 comprises one or more input elements (e.g. buttons, a touch pad and/or touchscreen) and a display screen configured to display one or more of the images generated by the image processing circuitry 140. For example, the information processing apparatus 100 may be a user device such as a laptop computing device, a smartphone device or tablet computing device.

Hence more generally, the information processing apparatus is operable to receive one or more user inputs for controlling one or more aspects of processing performed by the information processing apparatus. One or more user inputs can be used by the selection circuitry 140 for selecting a subset (portion) of the tile information stored by the storage circuitry 130, and the selected subset of the tile information can be used for generating one or more images for display. Hence, a user can specify one or more parts which are desired to be viewed by the user and the user input(s) by the user can be processed to search the tile information and retrieve a subset of the tile information corresponding to the one or more parts. In particular, the information processing device can process the user input so as to map the user input to one or more one-dimensional keys and selection with respect to the stored tile information can be performed using one or more one-dimensional keys.

One or more user inputs specifying a time and a memory address (i.e. two-dimensional information) can be processed to obtain one or more one-dimensional keys. In particular, the mapping operations discussed previously with respect to the mapping circuitry 120 in FIG. 1 to map the information (time information and memory address information) for a respective memory allocation to a 1D key for the purpose of storing the information in an appropriate entry associated with the 1D key, can similarly be performed with respect to a user input specifying a time and memory address to obtain a 1D key for use in performing a search of the tile information (e.g. to search for the tile comprising the entry).

Hence, the information processing device storing the tile information is operable to receive a user input indicative of at least one time and memory address, the mapping circuitry is operable to map the time and memory address to a 1D key (using a same function used previously by the mapping circuitry when obtaining 1D keys for use in storing the information in the entries of the tiles), and the selection circuitry is operable to select at least some of the tile information in dependence on the 1D key derived from the user input.

In some examples, the user input may specify a time and memory address coordinate. For example, a user may view a display image displaying a visualisation of a two-dimensional space having a time axis and a memory address axis and use a pointer device (e.g. mouse) to specify a coordinate. In some examples, the user input may specify a single coordinate and processing may be performed to derive a 2D range in the two-dimensional space centred on the specified coordinate. For example, a user may specify a single 2D coordinate and a predetermined calculation may be used to calculate a first 2D coordinate and a second 2D coordinate corresponding to a lower and upper coordinate, respectively, for defining a 2D range centred on the single 2D coordinate. In other examples, a user may specify two or more 2D coordinates for defining a 2D range in the two-dimensional space. For example, a square or rectangular area in a display image comprising a time axis and address axis may be specified (e.g. by a click and drag operation using a pointer device).

In some embodiments of the disclosure, the user input is indicative of a first two-dimensional coordinate with respect to the two-dimensional space and a second two-dimensional coordinate with respect to the two-dimensional space, and the mapping circuitry is configured to respectively map the first two-dimensional coordinate and the second two-dimensional coordinate to two respective one-dimensional keys, in which the two respective one-dimensional keys represent a one-dimensional search range with respect to the tile information. The first two-dimensional coordinate and the second two-dimensional coordinate may correspond to opposite corners of a square or rectangular region in the two-dimensional space such that the first two-dimensional coordinate corresponds to a minimum time and minimum address within the two-dimensional space and the second two-dimensional coordinate corresponds to a maximum time and maximum address within the two-dimensional space.

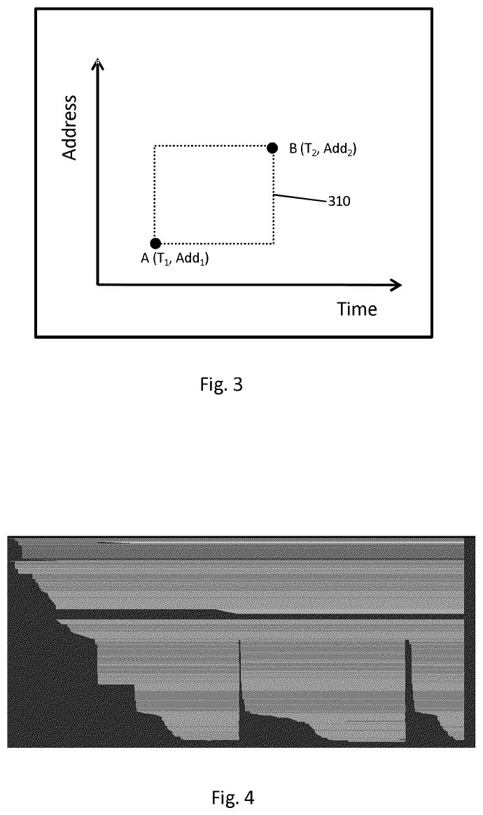

FIG. 3 schematically illustrates an example of two coordinates A and B specified by a user with respect to an image displaying a 2D space having a time axis and a memory address axis. The two coordinates A and B define a 2D range 310 within the 2D space. The coordinate A specifies a minimum time and minimum address (T₁, Add₁) and the coordinate B specifies a maximum time and maximum address (T₂, Add₂) for the range 310. The two coordinates A and B can be respectively mapped to respective 1D keys by the mapping circuitry. The two 1D keys thus define a 1D search range for searching the tile information to retrieve tiles comprising entries associated with 1D keys within the 1D search range. Hence, on the basis of the two 1D keys, tiles each comprising at least one entry associated with a key within the search range can be selected and the information retrieved for use in generating an image for display. In this way, 2D information (time information and memory address information) for memory allocations corresponding to the range 310 can be quickly and efficiently selected and provided to the image processing circuitry for use in generating an image for displaying information corresponding to the range 310.

Hence, more generally, in some embodiments of the disclosure, the selection circuitry is configured to select a subset of the tile information in dependence on two respective one-dimensional keys derived in dependence on a user input. The respective one-dimensional keys define a range with one of the two keys representing an upper limit on the range and the other of the two keys representing a lower limit on the range. The selection circuitry can range query the tile information in dependence on the two respective one-dimensional keys by comparing the two respective one-dimensional keys with nodes of a search tree to determine one or more tiles that corresponds to the search range and return the one or more tiles that corresponds to the search range. Optionally, instead of returning tiles, in response to determining that a tile corresponds to the search range, searching within that tile may then be performed to return a subset (one or more) of the entries which correspond to the search range.

Generally speaking, a search tree data structure (e.g. a binary search tree) allows fast query times for range querying. A range query on a search tree reports the nodes of the tree that fall within the range and the nodes so that information (time and memory address information) associated with those nodes can be reported. In particular, a range query on a search tree using a first key and a second key will generally result in two search paths that diverge at a given node within the search tree and on this basis nodes in one or more sub-trees can be reported as being within the range. For example, in the case of a binary search tree, a given node has a left subtree comprising nodes for which all the keys are less than that of the given node and a right subtree comprising nodes for which all the keys are greater than the of the given node. Hence, this property of a binary search tree can be exploited so that a given node at which the two search paths diverge can be used to quickly and efficiently report the nodes within the range and thus the information associated with those nodes.

In some embodiments of the disclosure, a search tree comprises nodes which can be range queried using the two respective one-dimensional keys derived in dependence on a user input. In an example, each leaf node of the tree (that is, each node with no child nodes) corresponds to a respective tile.

In some embodiments of the disclosure, one or more of the images generated by the image processing circuitry comprise a visual representation of the at least some of the tile information and a visual representation of a time axis and a memory address axis. FIG. 4 schematically illustrates an example of an image generated by the image processing circuitry in dependence on a subset of the stored tile information selected by the selection circuitry. In the example of FIG. 4, time is represented in the horizontal axis and memory address is represented in the vertical axis. The black areas of the image signify timings at which a given memory address is not allocated and the shaded areas of the image signify timings at which a given memory address is allocated. In an example, the image is generated on a tile basis so that the portion of the image associated within a given tile is black if no entry associated with the tile has been allocated or shaded if at least one entry associated with the tile has been allocated.

In some embodiments of the disclosure, the tile information comprises two or more hierarchical levels, in which a first hierarchical level comprises a first plurality of tiles corresponding to the two-dimensional space filled by the space-filling curve and the second hierarchical level comprises a second plurality of tiles corresponding to the two-dimensional space filled by the space-filling curve, each of the first plurality of tiles having a two-dimensional area that is smaller than a two-dimensional area of each tile in the second plurality of tiles. Hence, the stored tile information can comprise two or more levels each using a different tile size and one of the two or more levels can be selected and range queried using the derived 1D keys.

In some embodiments of the disclosure, the selection circuitry is configured to select the subset of the tile information from one of the first hierarchy level and the second hierarchy level in dependence on a zoom setting.

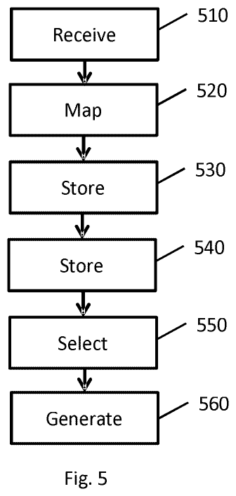

FIG. 5 is a schematic flowchart illustrating a method for processing memory allocation information. The method comprises:
receiving (at a step 510) memory allocation information for a plurality of memory allocations, the memory allocation information comprising time information and memory address information for a respective memory allocation, the time information being indicative of a start time and an end time for the respective memory allocation;
mapping (at a step 520) the time information and the memory address information for the respective memory allocation to a one-dimensional key of a space-filling curve, in which unique one-dimensional keys of the space-filling curve correspond to respective points in a two-dimensional space having a time axis and a memory address axis;
storing (at a step 530) tile information comprising a plurality of two-dimensional tiles, a respective tile corresponding to a portion of the two-dimensional space and comprising entries associated with keys corresponding to that portion of the two-dimensional space;
storing (at a step 540) the time information and the memory address information for the respective memory allocation in an entry associated with the one-dimensional key obtained for the respective memory allocation;
selecting (at a step 550) at least some of the tile information in dependence on a user input; and
generating (at a step 560) one or more images for display in dependence on the at least some of the tile information.

Example(s) of the present technology are defined by the following numbered clauses:
1. An information processing apparatus comprising:
   input circuitry to receive memory allocation information for a plurality of memory allocations, the memory allocation information comprising time information and memory address information for a respective memory allocation, the time information being indicative of a start time and an end time for the respective memory allocation;
   mapping circuitry to map the time information and the memory address information for the respective memory allocation to a one-dimensional key of a space-filling curve, in which unique one-dimensional keys of the space-filling curve correspond to respective points in a two-dimensional space having a time axis and a memory address axis;
   storage circuitry to store tile information comprising a plurality of tiles, a respective tile corresponding to a portion of the two-dimensional space and comprising entries associated with keys corresponding to that portion of the two-dimensional space, in which the storage circuitry is configured to store the time information and the memory address information for the respective memory allocation in an entry associated with the one-dimensional key obtained by the mapping circuitry for the respective memory allocation;
   selection circuitry to select at least some of the tile information in dependence on a user input; and
   image processing circuitry to generate one or more images for display in dependence on the at least some of the tile information.
2. The information processing apparatus according to any preceding clause, in which the storage circuitry is configured to store the tile information using one or more search trees, in which the one or more search trees comprise one or more from the list consisting of:
   a binary search tree;
   a radix tree; and
   an adaptive radix tree.
3. The information processing apparatus according to clause 1 or clause 2, in which the selection circuitry is configured to select a subset of the tile information in dependence on two respective one-dimensional keys derived in dependence on a user input.
4. The information processing apparatus according to clause 3, in which the selection circuitry is configured to perform a range query on of one of a search tree, a radix tree and an adaptive radix tree storing the tile information using the two respective one-dimensional keys.
5. The information processing apparatus according to clause 4, in which the selection circuitry is configured to return one or more of the plurality of tiles, the one or more tiles each comprising at least one entry associated with a key corresponding to a range defined by the two respective one-dimensional keys.
6. The information processing apparatus according to any one of clauses 3 to 5, in which the user input is indicative of a first two-dimensional coordinate and a second two-dimensional coordinate and the mapping circuitry is configured to respectively map the first two-dimensional coordinate and the second two-dimensional coordinate to the two respective one-dimensional keys, in which the two respective one-dimensional keys represent a one-dimensional search range with respect to the tile information.
7. The information processing apparatus according to any preceding clause, in which one or more of the image comprises a visual representation of the at least some of the tile information and a visual representation of a time axis and a memory address axis.
8. The information processing apparatus according to any preceding clause, in which the tile information comprises two or more hierarchical levels, in which a first hierarchical level comprises a first plurality of tiles corresponding to the two-dimensional space and the second hierarchical level comprises a second plurality of tiles corresponding to the two-dimensional space, each of the first plurality of tiles having a two-dimensional area that is smaller than a two-dimensional area of each tile in the second plurality of tiles.
9. The information processing apparatus according to clause 8, in which the selection circuitry is configured to select the subset of the tile information from one of the first hierarchy level and the second hierarchy level in dependence on a zoom setting.
10. The information processing apparatus according to any preceding clause, in which each of the unique one-dimensional keys of the space-filling curve is a 64-bit binary code.
11. The information processing apparatus according to any preceding clause, in which in response to the receiving circuitry receiving at least one of time information comprising an M-bit binary code and memory address information comprising an M-bit binary code, wherein M is a value in the range 33 to 64, the mapping circuitry is configured to map 32-bits of the time information and 32-bits of the memory address information to a 64-bit binary code as the one dimensional key.
12. The information processing apparatus according to clause 11, in which in response to the time information comprising a 64-bit binary code, the mapping circuitry is configured to remove the 16 least significant bits and the 16 most significant bits of the time information.
13. The information processing apparatus according to clause 11 or clause 12, in which in response to the memory address information comprising a 64-bit binary code, the mapping circuitry is configured to remove the most significant bits of the memory address information to obtain 32-bits of the memory address information.
14. The information processing apparatus according to any preceding clause, in which the space-filling curve is a Morton space-filling curve, and the mapping circuitry is configured to map the time information and the memory address information using a Morton function.
15. A computer-implemented method comprising:
   receiving memory allocation information for a plurality of memory allocations, the memory allocation information comprising time information and memory address information for a respective memory allocation, the time information being indicative of a start time and an end time for the respective memory allocation;
   mapping the time information and the memory address information for the respective memory allocation to a one-dimensional key of a space-filling curve, in which unique one-dimensional keys of the space-filling curve correspond to respective points in a two-dimensional space having a time axis and a memory address axis;
   storing tile information comprising a plurality of two-dimensional tiles, a respective tile corresponding to a portion of the two-dimensional space and comprising entries associated with keys corresponding to that portion of the two-dimensional space;
   storing the time information and the memory address information for the respective memory allocation in an entry associated with the one-dimensional key obtained for the respective memory allocation;
   selecting at least some of the tile information in dependence on a user input; and
   generating one or more images for display in dependence on the at least some of the tile information.
16. Computer software which when executed by a computer causes the computer to perform the method according to clause 15.

It will be appreciated that example embodiments can be implemented by computer software operating on a general purpose computing system. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

Thus any required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

It will also be apparent that numerous modifications and variations of the present disclosure are possible in light of the above teachings. It is therefore to be understood that within the scope of the appended claims, the disclosure may be practised otherwise than as specifically described herein.

1. An information processing apparatus comprising:
input circuitry to receive memory allocation information for a plurality of memory allocations, the memory allocation information comprising time information and memory address information for a respective memory allocation, the time information being indicative of a start time and an end time for the respective memory allocation;
mapping circuitry to map the time information and the memory address information for the respective memory allocation to a one-dimensional key of a space-filling curve, in which unique one-dimensional keys of the space-filling curve correspond to respective points in a two-dimensional space having a time axis and a memory address axis;
storage circuitry to store tile information comprising a plurality of tiles, a respective tile corresponding to a portion of the two-dimensional space and comprising entries associated with keys corresponding to that portion of the two-dimensional space, in which the storage circuitry is configured to store the time information and the memory address information for the respective memory allocation in an entry associated with the one-dimensional key obtained by the mapping circuitry for the respective memory allocation;
selection circuitry to select at least some of the tile information in dependence on a user input; and
image processing circuitry to generate one or more images for display in dependence on the at least some of the tile information.

2. The information processing apparatus of claim 1, in which the storage circuitry is configured to store the tile information using one or more search trees, in which the one or more search trees comprise one or more from the list consisting of:
a binary search tree;
a radix tree; and
an adaptive radix tree.

3. The information processing apparatus of claim 1, in which the selection circuitry is configured to select a subset of the tile information in dependence on two respective one-dimensional keys derived in dependence on a user input.

4. The information processing apparatus of claim 3, in which the selection circuitry is configured to perform a range query on of one of a search tree, a radix tree and an adaptive radix tree storing the tile information using the two respective one-dimensional keys.

5. The information processing apparatus of claim 4, in which the selection circuitry is configured to return one or more of the plurality of tiles, the one or more tiles each comprising at least one entry associated with a key corresponding to a range defined by the two respective one-dimensional keys.

6. The information processing apparatus of claim 3, in which the user input is indicative of a first two-dimensional coordinate and a second two-dimensional coordinate and the mapping circuitry is configured to respectively map the first two-dimensional coordinate and the second two-dimensional coordinate to the two respective one-dimensional keys, in which the two respective one-dimensional keys represent a one-dimensional search range with respect to the tile information.

7. The information processing apparatus of claim 1, in which one or more of the image comprises a visual representation of the at least some of the tile information and a visual representation of a time axis and a memory address axis.

8. The information processing apparatus of claim 1, in which the tile information comprises two or more hierarchical levels, in which a first hierarchical level comprises a first plurality of tiles corresponding to the two-dimensional space and the second hierarchical level comprises a second plurality of tiles corresponding to the two-dimensional space, each of the first plurality of tiles having a two-dimensional area that is smaller than a two-dimensional area of each tile in the second plurality of tiles.

9. The information processing apparatus of claim 8, in which the selection circuitry is configured to select the subset of the tile information from one of the first hierarchy level and the second hierarchy level in dependence on a zoom setting.

10. The information processing apparatus of claim 1, in which each of the unique one-dimensional keys of the space-filling curve is a 64-bit binary code.

11. The information processing apparatus of claim 1, in which in response to the receiving circuitry receiving at least one of time information comprising an M-bit binary code and memory address information comprising an M-bit binary code, wherein M is a value in the range 33 to 64, the mapping circuitry is configured to map 32-bits of the time information and 32-bits of the memory address information to a 64-bit binary code as the one dimensional key.

12. The information processing apparatus of claim 11, in which in response to the time information comprising a 64-bit binary code, the mapping circuitry is configured to remove the 16 least significant bits and the 16 most significant bits of the time information.

13. The information processing apparatus of claim 11, in which in response to the memory address information comprising a 64-bit binary code, the mapping circuitry is configured to remove the most significant bits of the memory address information to obtain 32-bits of the memory address information.

14. The information processing apparatus of claim 1, in which the space-filling curve is a Morton space-filling curve, and the mapping circuitry is configured to map the time information and the memory address information using a Morton function.

15. A computer-implemented method comprising:
receiving memory allocation information for a plurality of memory allocations, the memory allocation information comprising time information and memory address information for a respective memory allocation, the time information being indicative of a start time and an end time for the respective memory allocation;
mapping the time information and the memory address information for the respective memory allocation to a one-dimensional key of a space-filling curve, in which unique one-dimensional keys of the space-filling curve correspond to respective points in a two-dimensional space having a time axis and a memory address axis;
storing tile information comprising a plurality of two-dimensional tiles, a respective tile corresponding to a portion of the two-dimensional space and comprising entries associated with keys corresponding to that portion of the two-dimensional space;
storing the time information and the memory address information for the respective memory allocation in an entry associated with the one-dimensional key obtained for the respective memory allocation;
selecting at least some of the tile information in dependence on a user input; and
generating one or more images for display in dependence on the at least some of the tile information.

16. The method of claim 15, in which the storage circuitry is configured to store the tile information using one or more search trees, in which the one or more search trees comprise one or more from the list consisting of:
a binary search tree;
a radix tree; and
an adaptive radix tree.

17. The method of claim 15, in which the selection circuitry is configured to select a subset of the tile information in dependence on two respective one-dimensional keys derived in dependence on a user input.

18. One or more non-transitory computer storage media encoded with computer program instructions that when executed by a plurality of computers cause the plurality of computers to perform operations comprising: receiving memory allocation information for a plurality of memory allocations, the memory allocation information comprising time information and memory address information for a respective memory allocation, the time information being indicative of a start time and an end time for the respective memory allocation;
mapping the time information and the memory address information for the respective memory allocation to a one-dimensional key of a space-filling curve, in which unique one-dimensional keys of the space-filling curve correspond to respective points in a two-dimensional space having a time axis and a memory address axis;
storing tile information comprising a plurality of two-dimensional tiles, a respective tile corresponding to a portion of the two-dimensional space and comprising entries associated with keys corresponding to that portion of the two-dimensional space;
storing the time information and the memory address information for the respective memory allocation in an entry associated with the one-dimensional key obtained for the respective memory allocation;
selecting at least some of the tile information in dependence on a user input; and
generating one or more images for display in dependence on the at least some of the tile information.

19. The non-transitory computer storage media of claim 18, in which the storage circuitry is configured to store the tile information using one or more search trees, in which the one or more search trees comprise one or more from the list consisting of:
a binary search tree;
a radix tree; and
an adaptive radix tree.

20. The non-transitory computer storage media of claim 18, in which the selection circuitry is configured to select a subset of the tile information in dependence on two respective one-dimensional keys derived in dependence on a user input.
